(19) United States
(12) Patent Application Publication
(10) Pub. No.: US 2026/0340079 A1
(43) Pub. Date: Oct. 29, 2026

(54) MACHINE LEARNING-BASED RECOMMENDATION SYSTEM WITH DATA STRUCTURE PROCESSING

(71) Applicant: Dell Products L.P., Round Rock, TX (US)

(72) Inventors: Bijan Kumar Mohanty, Austin, TX (US); Manoj Nambirajan, Hyderabad (IN); Hung T. Dinh, Austin, TX (US); Mohit Kumar Agarwal, Cyberjaya (MY)

(21) Appl. No.: 19/188,524

(22) Filed: Apr. 24, 2025

(51) Int. Cl. G06F 18/214; G06N 20/00

(52) U.S. Cl. CPC G06F 18/214; G06N 20/00

(57) ABSTRACT

Methods, apparatus, and processor-readable storage media for implementing a machine learning-based recommendation system with data structure processing are provided herein. An example computer-implemented method includes identifying features within input data associated with at least one action-based use case; determining, by processing at least a portion of the features using machine learning techniques, portions of historical data associated with use cases having at least a designated level of similarity to the action-based use case(s); identifying, within the determined portions of historical data, one or more activities carried out in furtherance of the use cases having at least a designated level of similarity to the action-based use case(s); generating one or more context-specific recommendations of one or more actions to be carried out in furtherance of the action-based use case(s) by processing the identified activities using generative artificial intelligence; and performing one or more automated actions based on the generated context-specific recommendation(s).

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Data processing performance can impact a multitude of use case contexts negatively or positively. However, in many such contexts, conventional data processing approaches can produce inconsistent results and performance discrepancies, which can lead to errors, latencies, and/or resource-intensive remedial actions.

### SUMMARY

Illustrative embodiments of the disclosure provide techniques for machine learning-based recommendation systems with data structure processing.

An example computer-implemented method includes identifying one or more features within input data associated with at least one action-based use case, and determining, by processing at least a portion of the one or more features within the input data using one or more machine learning techniques, one or more portions of historical data associated with one or more use cases having at least a designated level of similarity to the at least one action-based use case. The method also includes identifying, within the one or more determined portions of historical data, one or more activities carried out in furtherance of the one or more use cases having at least a designated level of similarity to the at least one action-based use case. Further, the method additionally includes generating one or more context-specific recommendations of one or more actions to be carried out in furtherance of the at least one action-based use case by processing the one or more identified activities using one or more generative artificial intelligence techniques, and performing one or more automated actions based at least in part on the one or more generated context-specific recommendations.

Illustrative embodiments can provide significant advantages relative to conventional data processing approaches. For example, problems associated with errors, latencies, and/or resource-intensive remedial actions arising from inconsistent results and performance discrepancies are overcome in one or more embodiments through automatically generating actionable recommendations for an input use case by processing historical data using machine learning techniques and generative artificial intelligence.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for machine learning-based recommendation generation with data structure processing in an illustrative embodiment.

FIG. 2 shows example architecture for a machine learning-based recommendation system in an illustrative embodiment.

FIG. 3 shows example system architecture for a similarity-based prediction engine in an illustrative embodiment.

FIG. 4 shows example pseudocode for implementing at least a portion of a similarity-based prediction engine in an illustrative embodiment.

FIG. 5 shows example pseudocode for implementing at least a portion of a similarity-based prediction engine in an illustrative embodiment.

FIG. 6 shows example pseudocode for implementing at least a portion of a similarity-based prediction engine in an illustrative embodiment.

FIG. 7 shows example pseudocode for implementing at least a portion of a similarity-based prediction engine in an illustrative embodiment.

FIG. 8 shows example pseudocode for implementing at least a portion of a similarity-based prediction engine in an illustrative embodiment.

FIG. 9 shows example pseudocode for implementing at least a portion of a similarity-based prediction engine in an illustrative embodiment.

FIG. 10 shows example pseudocode for implementing at least a portion of a similarity-based prediction engine in an illustrative embodiment.

FIG. 11 shows example pseudocode for implementing at least a portion of a recommendation determination engine in an illustrative embodiment.

FIG. 12 shows example pseudocode for implementing at least a portion of an actionable recommendation generation engine in an illustrative embodiment.

FIG. 13 is a flow diagram of a process for implementing a machine learning-based recommendation system with data structure processing in an illustrative embodiment.

FIGS. 14 and 15 show examples of processing platforms that may be utilized to implement at least a portion of an information processing system in illustrative embodiments.

### DETAILED DESCRIPTION

Illustrative embodiments will be described herein with reference to example computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

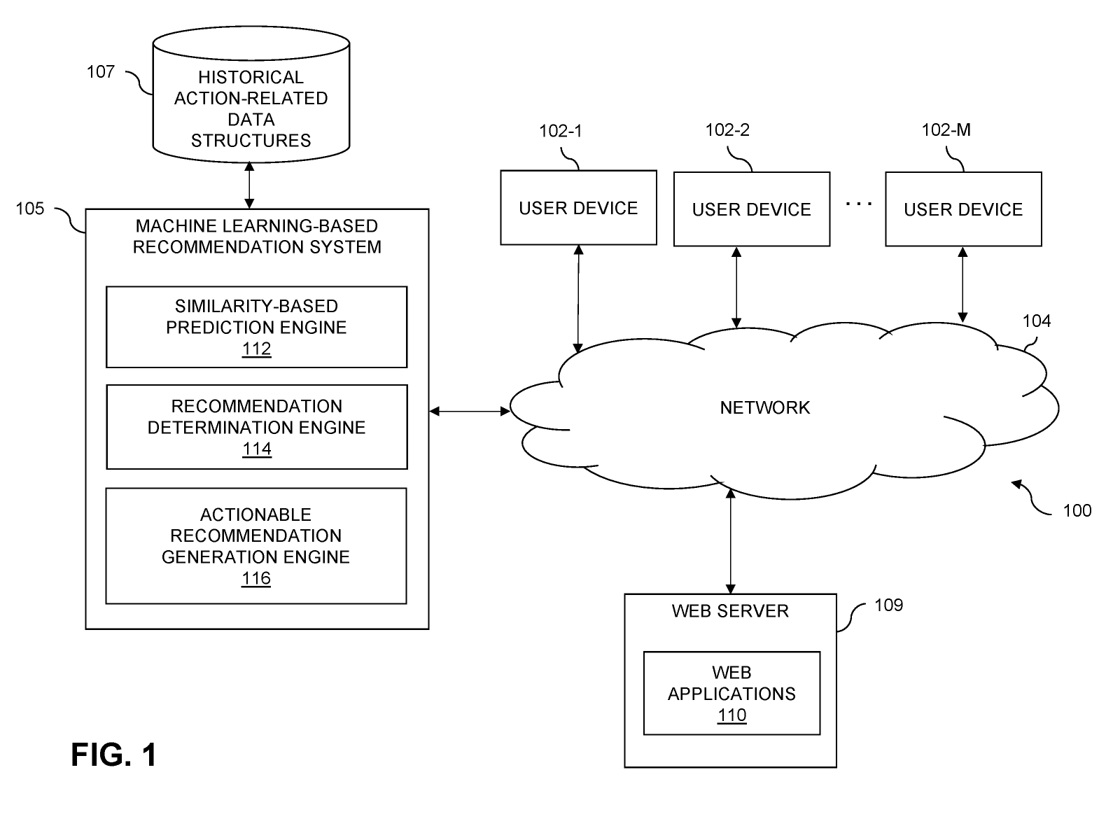

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is machine learning-based recommendation system 105 and web server 109, upon which one or more web applications 110 execute (e.g., one or more e-commerce applications, one or more customer relationship (CRM) applications, etc.).

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the machine learning-based recommendation system 105 can have one or more historical action-related data structures 107 configured to store data pertaining to previous actions (e.g., system actions, user actions, etc.) related to various contexts and/or use cases (e.g., transaction-related use cases). The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The historical action-related data structures 107 in the present embodiment are implemented using one or more storage systems associated with the machine learning-based recommendation system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the machine learning-based recommendation system 105 are one or more input-output devices, which illustratively comprise keyboards, displays or other types of input-output devices in any combination. Such input-output devices can be used, for example, to support one or more user interfaces to the machine learning-based recommendation system 105, as well as to support communication between the machine learning-based recommendation system 105 and other related systems and devices not explicitly shown.

Additionally, the machine learning-based recommendation system 105 in the FIG. 1 embodiment is assumed to be implemented using at least one processing device. Each such processing device generally comprises at least one processor and an associated memory, and implements one or more functional modules for controlling certain features of the machine learning-based recommendation system 105.

More particularly, the machine learning-based recommendation system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the machine learning-based recommendation system 105 to communicate over the network 104 with the user devices 102, and illustratively comprises one or more conventional transceivers.

The machine learning-based recommendation system 105 further comprises a similarity-based prediction engine 112, a recommendation determination engine 114, and an actionable recommendation generation engine 116.

In one or more embodiments, the similarity-based prediction engine 112 can utilize at least one deep learning-based algorithm, such as a sparse autoencoder, to cluster historical data from historical action-related data structures 107, based at least in part on one or more multi-dimensional features related to input data and/or an input query provided by user devices 102. Once clustered, the similarity-based prediction engine 112 can utilize at least one similarity algorithm to process the clustered data to identify at least a portion of the clustered data that is similar and/or closely matches at least a portion of the input data and/or the input query.

Also, in such an embodiment, the recommendation determination engine 114 accepts and/or processes one or more portions of the clustered data that is similar and/or closely matches at least a portion of the input data and/or the input query, as identified by the similarity-based prediction engine 112, and extracts information pertaining to one or more actions and/or activities associated with that historical data. Further, in such an embodiment, the actionable recommendation generation engine 116 generates one or more actionable recommendations as steps to be carried out in connection with the corresponding input data and/or input query (e.g., steps to be carried out by user devices 102 and/or one or more external systems). More particularly, the actionable recommendation generation engine 116 can process the one or more action items as extracted from the historical data by the recommendation determination engine 114, and leverage generative artificial intelligence (GenAI) techniques in conjunction with a retrieval-augmented generation (RAG) framework to generate context-specific steps to be carried out in furtherance of the input data and/or the input query.

It is to be appreciated that this particular arrangement of elements 112, 114 and 116 illustrated in the machine learning-based recommendation system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 implementing a machine learning-based recommendation system involving user devices 102 and historical action-related data structures 107 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of machine learning-based recommendation system 105, historical action-related data structures 107, user devices 102, and web server 109 can be on and/or part of the same processing platform.

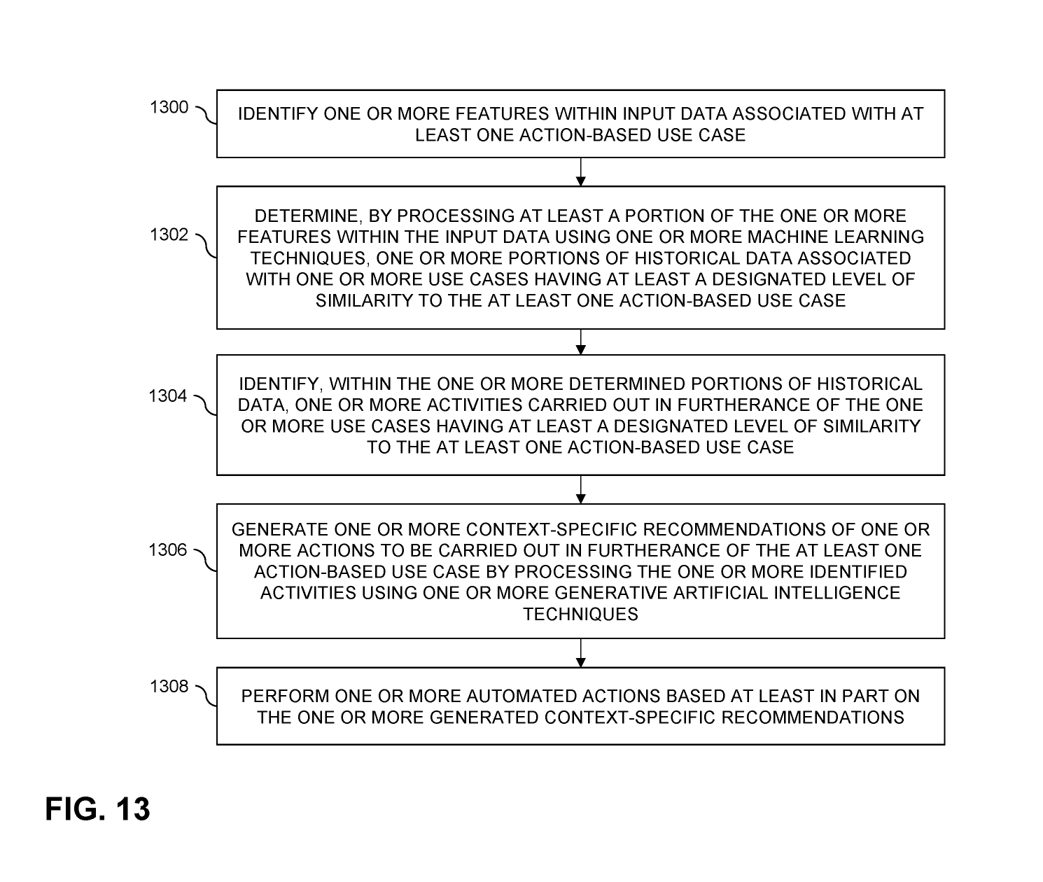

An example process utilizing elements 112, 114 and 116 of an example machine learning-based recommendation system 105 in computer network 100 will be described in more detail with reference to the flow diagram of FIG. 13.

Accordingly, at least one embodiment includes implementing a machine learning-based recommendation system with data structure processing. As detailed herein, such an embodiment can include leveraging one or more machine learning models by training such models using the historical data from one or more related and/or relevant use case contexts. For example, in connection with an enterprise transaction context, such historical data can include data pertaining to similar transactions, such as transaction category, product type, transaction size, user size, solution focus, and one or more other multidimensional attributes. Accordingly, such an embodiment can also include using the one or more trained machine learning models to generate one or more recommendations for targeted actions related to the use case and/or context in question (e.g., delivering targeted transaction-related opportunity insights).

Extracting one or more actionable recommendations from historical data (e.g., data pertaining to past successful transaction closures) using one or more specially trained machine learning models can facilitate enhancing and/or maximizing outcomes for related use cases and/or contexts. In one or more embodiments, extracting and/or generating such actionable recommendations can include leveraging one or more trained machine learning models to analyze use case-specific data (e.g., transaction attributes, actions taken, etc.), and based at least in part on such analysis, identifying clusters of relevant historical data (e.g., successful transactions with similar attributes to the transaction in question) and extracting information pertaining to one or more specific actions that led to at least one desired and/or positive outcome (e.g., one or more pricing strategies, one or more user engagement methods, follow up techniques, etc.).

At least one embodiment includes implementing a multi-step process leveraging deep learning and natural language processing (NLP) techniques to generate one or more actionable recommendations to enhance at least one use case and/or context. More particularly, in such an embodiment, at least one deep learning-based algorithm, such as a sparse autoencoder, is utilized to cluster historical data, by processing one or more data structures, based at least in part on one or more multi-dimensional features related to input data and/or an input query. Accordingly, an example embodiment can include using the at least one deep learning-based algorithm to identify successful transactions and/or deals that are similar in nature to a new opportunity based at least in part on multi-dimensional features. Such an embodiment can include using unsupervised learning techniques in conjunction with at least one deep learning based autoencoder to determine similar patterns of transactions and/or deals to create data clusters. In such an autoencoder, the neural network encodes the data to a lower dimension and, in the process, captures latent features which are used to group similar transactions and/or deals based on their features. Such an autoencoder can also include a decoder which decodes from the compressed features to its normal form.

Once clustered, at least one similarity algorithm can process the clustered data to identify at least a portion of the clustered data that is similar and/or closely matches at least a portion of the input data and/or the input query. At least one embodiment includes leveraging a K-means algorithm which uses cosine similarity to identify similar transactions and/or deals. At least a portion of the identified data is then processed using one or more NLP techniques and at least one classification algorithm to extract one or more actions and/or insights relevant to the input data and/or the input query. For example, the NLP techniques can be used to process notes associated with each transaction and/or deal that are similar to the new opportunity. During the process of analyzing a successful transaction and/or deal, for example, all activities carried out by the sales agent are captured in notes with the actions performed denoted by action words such as, e.g., “Takeaway,” “Action Items,” “Next Steps,” etc. The NLP techniques can also include using at least one spaCy library to extract such actions (for example, meeting conducted, proof of concept performed, etc.) from the notes.

Additionally, in connection with providing one or more actionable recommendations, at least one embodiment includes processing and/or synthesizing the extracted information using GenAI techniques (e.g., one or more generative pretrained transformers (GPTs), one or more pretrained and/or instruction-fine-tuned language models, etc.) in conjunction with at least one RAG framework. As used herein, a RAG framework refers to an architecture wherein domain-specific data is retrieved from at least one vector database and passed along with the question and/or prompt to at least one LLM to generate a more accurate reply. Such a GenAI-based component can be used in one or more embodiments to produce natural language instructions, for example, for a sales agent to take based at least in part on the action word(s) extracted from a previous NLP component.

Accordingly, one or more embodiments include implementing at least one proactive framework to generate one or more guided and/or actionable recommendations in response to use case-specific and/or context-specific input data and/or input queries by leveraging one or more machine learning algorithms, NLP techniques, and GenAI-RAG architecture trained on relevant multi-dimensional historical data. As such, at least one embodiment includes taking a new opportunity as input, identifying one or more similar successful previous transactions and/or deals, extracting action items from the notes associated with these identified transactions and/or deals, and generating natural language-based instructions for at least one agent associated with the new opportunity.

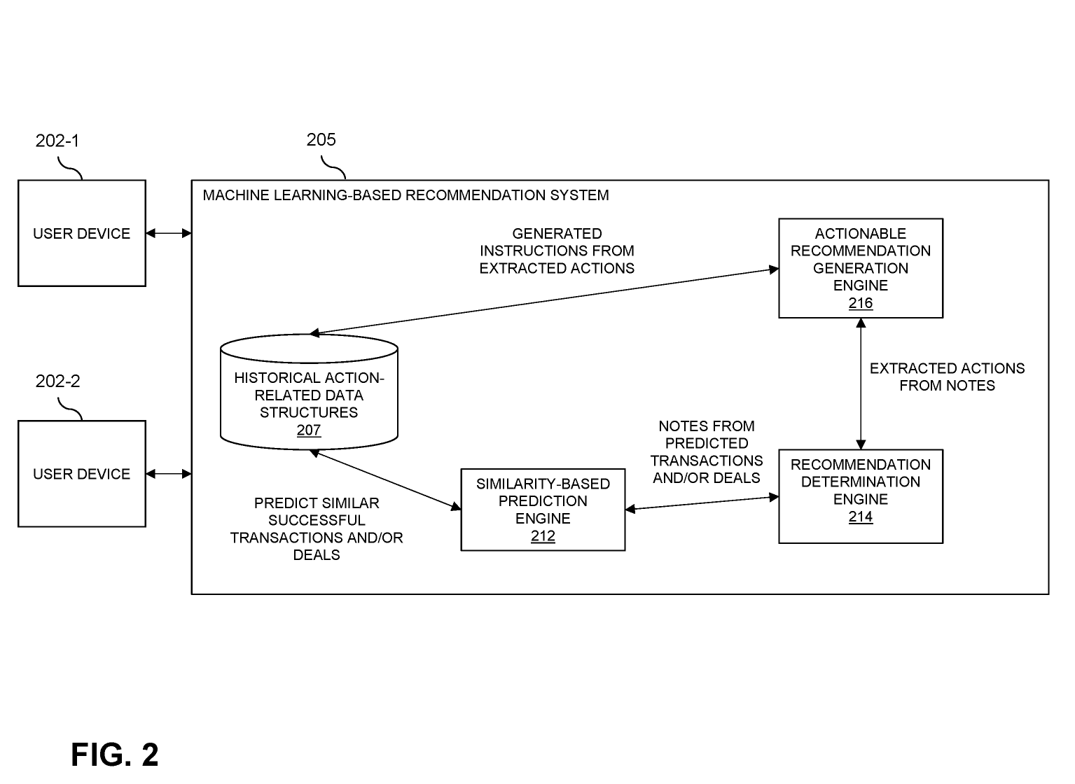

FIG. 2 shows example architecture for a machine learning-based recommendation system in an illustrative embodiment. By way of illustration, FIG. 2 depicts achieving multi-step capabilities by implementing, within machine learning-based recommendation system 205, historical action-related data structures 207, similarity-based prediction engine 212, recommendation determination engine 214, and actionable recommendation generation engine 216. In an example embodiment such as depicted in FIG. 2, the similarity-based prediction engine 212 processes input data and/or an input query submitted by user device 202-1 and/or user device 202-2 and, using relevant historical data from historical action-related data structures 207 (e.g., data structures associated with a CRM system) as training data, leverages an unsupervised learning approach to predict at least one configurable set of the historical data having one or more similarities to the input data and/or input query. In at least one embodiment, the similarity-based prediction engine 212 can include and/or utilize a neural network-based sparse autoencoder and similarity algorithm to generate the noted predictions.

In such an embodiment, the neural network-based sparse autoencoder is specifically configured and/or designed for one or more unsupervised learning tasks, such as dimensionality reduction and feature learning. When applied, by way of example, to clustering past sales transaction data based on a variety of features (e.g., product type, customer industry, deal amount, region etc.), the neural network-based sparse autoencoder can be utilized to help transform high-dimensional input data into a compressed, lower-dimensional representation. In connection with implementing such an autoencoder, an encoder part transforms the input data into a lower-dimensional latent space (e.g., a compressed version) using one or more layers of neurons that apply one or more nonlinear activation functions, allowing the model to capture complex and/or nonlinear relationships between features. This transformation enables the extraction of features (e.g., the most important features) from data, making it easier to execute clustering algorithms such as, e.g., a K-means clustering algorithm, to identify groups of similar transactions. Also, the compressed representation generated by the neural network-based sparse autoencoder allows for enhanced feature space organization, enabling a more effective identification of similar past transactions when compared to input data. After clustering, at least one similarity algorithm, such as, e.g., a nearest neighbors algorithm, can be applied to the encoded data to predict similar transactions (e.g., the 3-5 most similar transactions) relative to a current opportunity (related to the input data) based on one or more of its features.

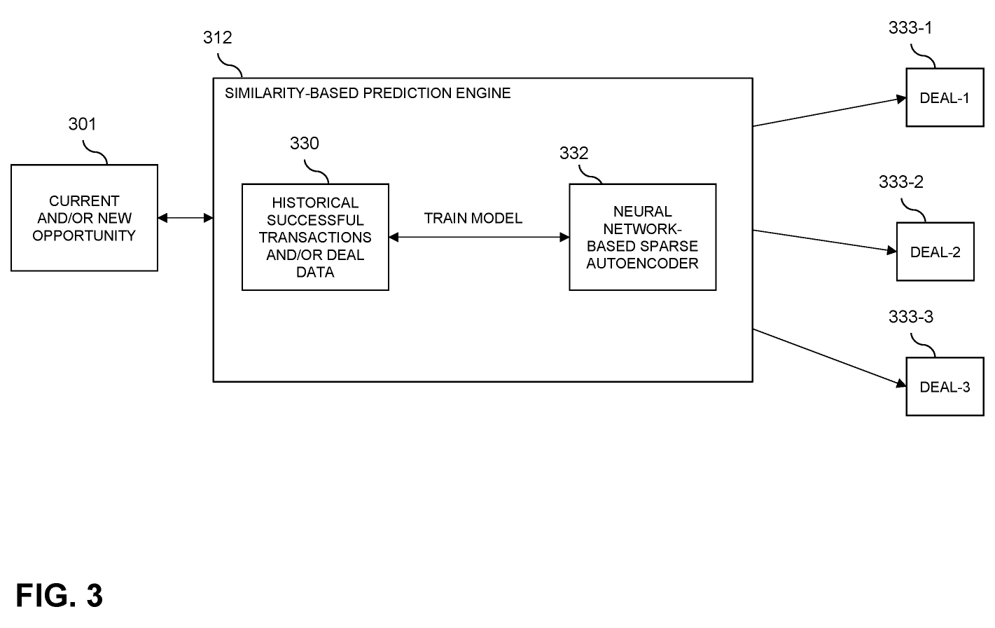

FIG. 3 shows example system architecture for a similarity-based prediction engine in an illustrative embodiment. By way of illustration, FIG. 3 depicts similarity-based prediction engine 312, which includes a dataset of successful deals 330 derived from historical data (e.g., historical data stored in data structures 107 and/or 207), and a type of autoencoder referred to as a neural network-based sparse autoencoder 332, wherein at least one additional sparsity constraint is applied to the encoded layer. Such a constraint ensures that only a small number of neurons are active at any given time during encoding. An advantage of using neural network-based sparse autoencoder 332 for this use case lies in its ability to create a more discriminative representation of the data by learning one or more features that are more interpretable and distinct. By enforcing sparsity, the neural network-based sparse autoencoder 332 avoids learning trivial identity mappings and focuses on more essential features needed for reconstructing the input. This property can be particularly beneficial for complex datasets with a variety of attributes, such as, for example, historical transaction data (such as, e.g., the dataset of successful deals 330).

Accordingly, in at least one embodiment such as depicted in FIG. 3, utilizing neural network-based sparse autoencoder 332 can help isolate significant features input data pertaining to a current customer opportunity 301, making the clustering of historical transactions (such as, e.g., among the dataset of successful deals 330) based at least in part on feature similarities more meaningful. For predicting similar transactions to an input transaction and/or opportunity, the sparse representation enhances the model’s ability to identify which past deals (e.g., deals 333-1, 333-2 and 333-3) closely resemble the input transaction and/or opportunity (e.g., as detailed within input data pertaining to a current customer opportunity 301).

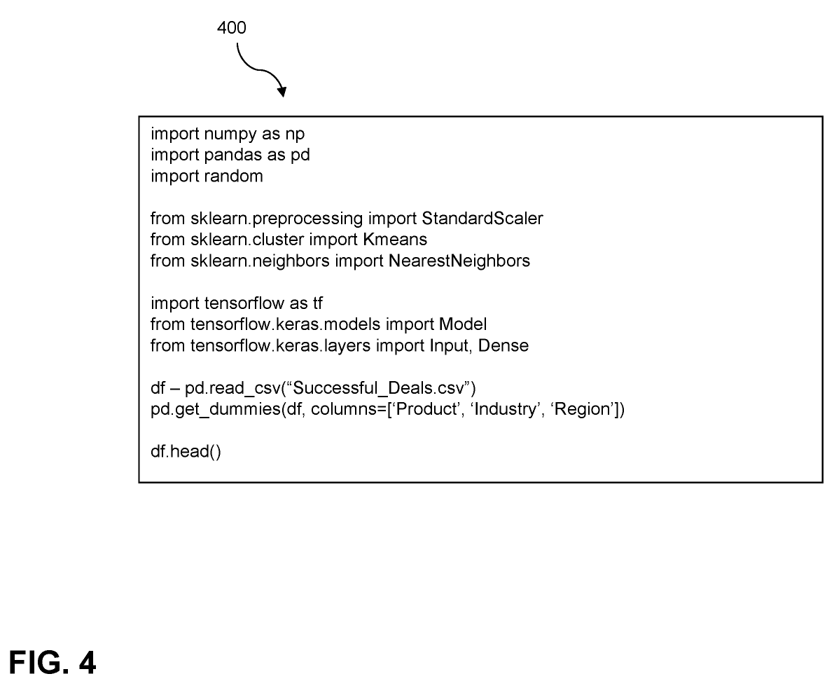

In one or more embodiments, a similarity-based prediction engine can be implemented in Python using Tensorflow, Keras, as well as Scikit-learn, Pandas and Numpy libraries, as illustrated and detailed below in connection with FIG. 4 through FIG. 10.

FIG. 4 shows example pseudocode for implementing at least a portion of a similarity-based prediction engine in an illustrative embodiment. In this embodiment, example pseudocode 400 is executed by or under the control of at least one processing system and/or device. For example, the example pseudocode 400 may be viewed as comprising a portion of a software implementation of at least part of machine learning-based recommendation system 105 of the FIG. 1 embodiment.

The example pseudocode 400 illustrates importing necessary libraries and feeding particular historical data (e.g., “successful deals”) from one or more corresponding data sources (e.g., a sales CRM system) as a comma-separated values (CSV) file, which is read and, based at least in part thereon, a Pandas dataframe is created. As one or more embodiments include implementing an unsupervised learning approach with clustering, the particular historical data will have various features (e.g., product, product category, customer size, customer industry, region, sales agent notes, etc.), but will not have defined target labels.

It is to be appreciated that this particular example pseudocode shows just one example implementation of at least a portion of a similarity-based prediction engine, and alternative implementations can be used in other embodiments.

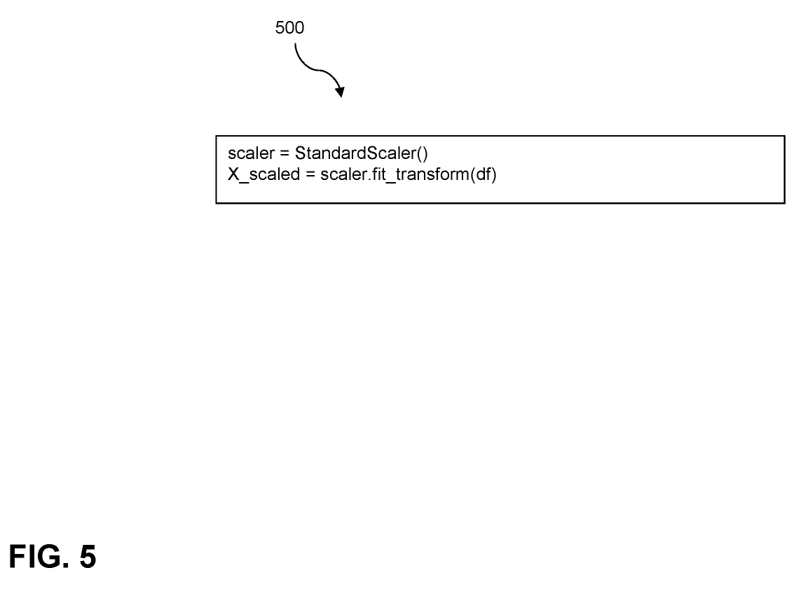

FIG. 5 shows example pseudocode for implementing at least a portion of a similarity-based prediction engine in an illustrative embodiment. In this embodiment, example pseudocode 500 is executed by or under the control of at least one processing system and/or device. For example, the example pseudocode 500 may be viewed as comprising a portion of a software implementation of at least part of machine learning-based recommendation system 105 of the FIG. 1 embodiment.

The example pseudocode 500 illustrates normalizing and/or standardizing the dataset (such as detailed in connection with FIG. 4) by scaling the dataset using StandardScaler, which ensures that all features have a mean of zero and a standard deviation of one, which helps to enhance model performance and training stability.

It is to be appreciated that this particular example pseudocode shows just one example implementation of at least a portion of a similarity-based prediction engine, and alternative implementations can be used in other embodiments.

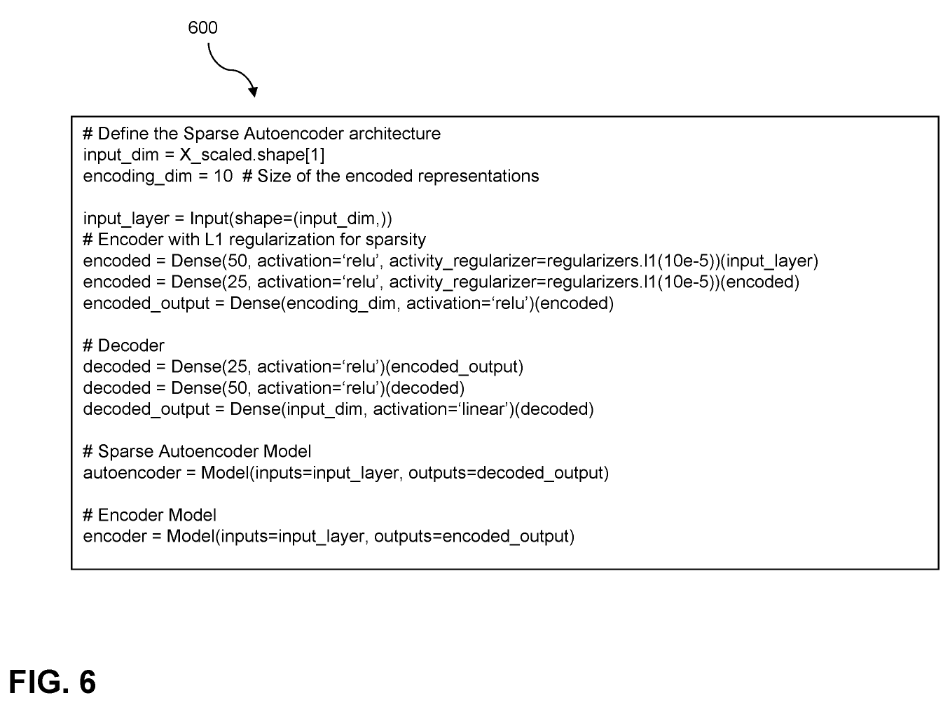

FIG. 6 shows example pseudocode for implementing at least a portion of a similarity-based prediction engine in an illustrative embodiment. In this embodiment, example pseudocode 600 is executed by or under the control of at least one processing system and/or device. For example, the example pseudocode 600 may be viewed as comprising a portion of a software implementation of at least part of machine learning-based recommendation system 105 of the FIG. 1 embodiment.

The example pseudocode 600 illustrates creating a sparse auto-encoder using a Keras function Model() with the input dimension defined as the same as the number of input features. More particularly, example pseudocode 600 illustrates creating a sparse auto-encoder architecture with three dense layers that reduce the dimensionality of the input data, with L1 regularization applied to encourage sparsity in the encoded representation. Also, a decoder architecture is defined which mirrors the encoder to reconstruct the input data from its reduced representation.

It is to be appreciated that this particular example pseudocode shows just one example implementation of at least a portion of a similarity-based prediction engine, and alternative implementations can be used in other embodiments.

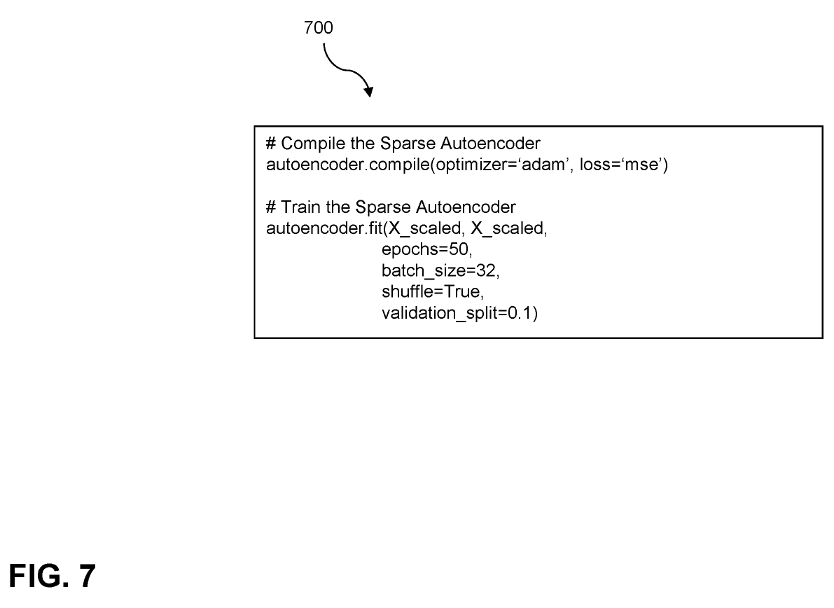

FIG. 7 shows example pseudocode for implementing at least a portion of a similarity-based prediction engine in an illustrative embodiment. In this embodiment, example pseudocode 700 is executed by or under the control of at least one processing system and/or device. For example, the example pseudocode 700 may be viewed as comprising a portion of a software implementation of at least part of machine learning-based recommendation system 105 of the FIG. 1 embodiment.

The example pseudocode 700 illustrates compiling the created sparse auto-encoder with an optimizer and a loss function. More particularly, as depicted in example pseudocode 700, one or more embodiments include using an adaptive moment estimation (Adam) algorithm as the optimizer and mean squared error (MSE) as the loss function. Further, as also illustrated in example pseudocode 700, the compiled sparse auto-encoder is trained by passing scaled features data into the fit() function. Once trained, the auto-encoder is ready to reconstruct the input dataset, minimizing the reconstruction loss.

It is to be appreciated that this particular example pseudocode shows just one example implementation of at least a portion of a similarity-based prediction engine, and alternative implementations can be used in other embodiments.

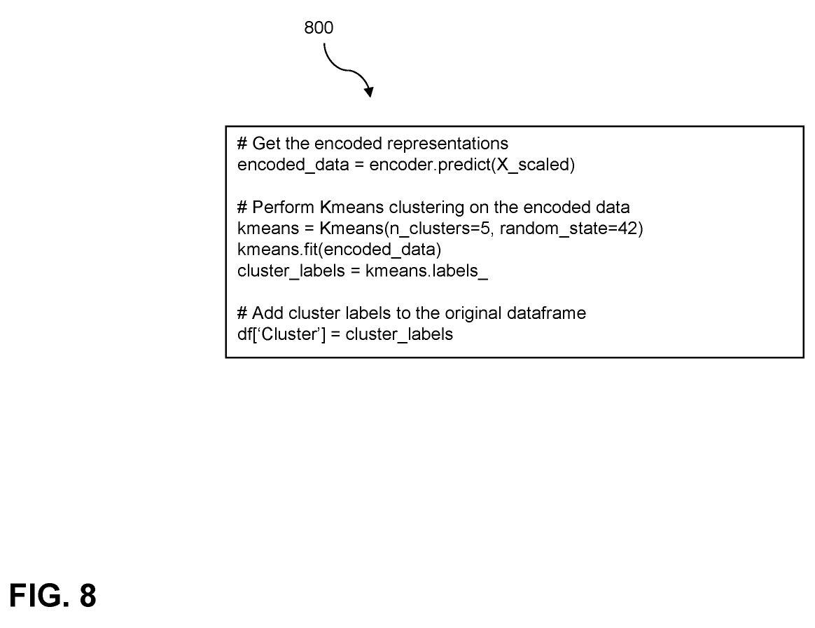

FIG. 8 shows example pseudocode for implementing at least a portion of a similarity-based prediction engine in an illustrative embodiment. In this embodiment, example pseudocode 800 is executed by or under the control of at least one processing system and/or device. For example, the example pseudocode 800 may be viewed as comprising a portion of a software implementation of at least part of machine learning-based recommendation system 105 of the FIG. 1 embodiment.

The example pseudocode 800 illustrates using the trained encoder of the auto-encoder to generate at least one encoded part of the original dataset, which can represent the lower dimensional embeddings that capture the essence of the original dataset. Further, example pseudocode 800 illustrates performing K-means clustering on the encoded data (e.g., clustering the encoded data into five groups) and adding one or more cluster labels to the corresponding portions of the original dataset (e.g., adding such information to the original dataframe as a new column named “cluster”).

It is to be appreciated that this particular example pseudocode shows just one example implementation of at least a portion of a similarity-based prediction engine, and alternative implementations can be used in other embodiments.

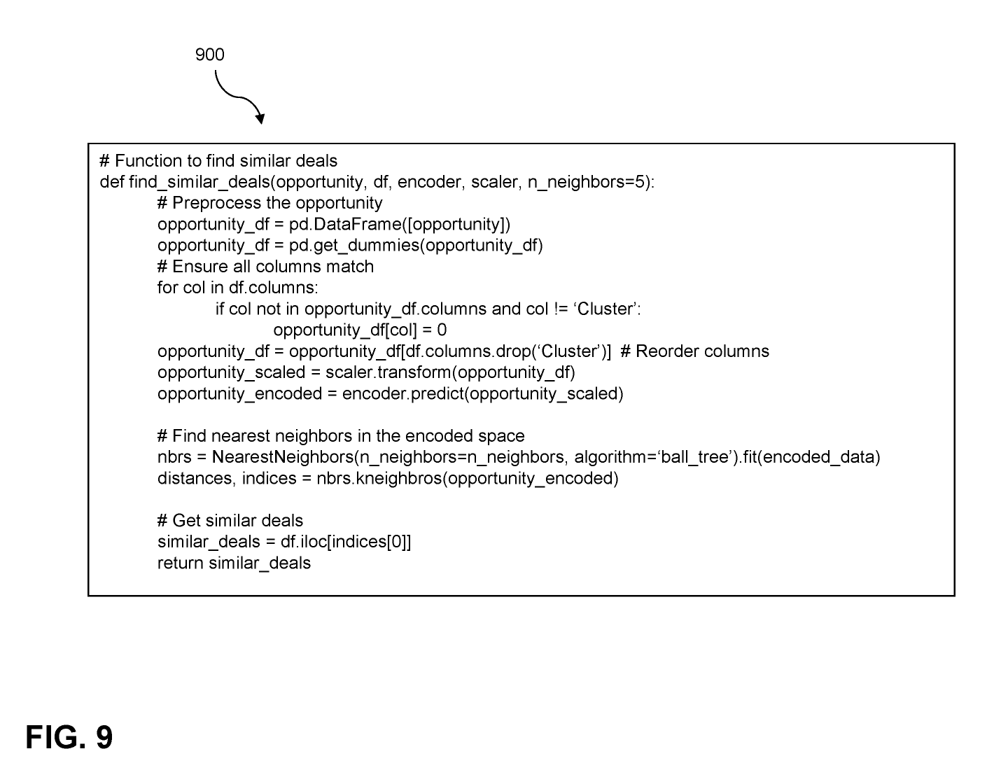

FIG. 9 shows example pseudocode for implementing at least a portion of a similarity-based prediction engine in an illustrative embodiment. In this embodiment, example pseudocode 900 is executed by or under the control of at least one processing system and/or device. For example, the example pseudocode 900 may be viewed as comprising a portion of a software implementation of at least part of machine learning-based recommendation system 105 of the FIG. 1 embodiment.

The example pseudocode 900 illustrates using the sparse auto-encoder to generate one or more predictions. In the embodiment depicted in example pseudocode 900, a new transaction-related opportunity is encoded into a dataframe and the categorical values are encoded using one-hot encoding to match the original training dataset. After missing values are handled, the data is standardized and/or normalized using StandardScaler, the scaled opportunity data is passed through the trained encoder to generate its lower dimensional encoding. The nearest neighbors (of historical deal-related data) in the encoded space are identified using a nearest neighbors algorithm that utilizes one or more cosine similarity and/or Euclidian distance algorithms. The number of neighbors is configurable (in example pseudocode 900, the number is set at five). Also, as illustrated in example pseudocode 900, distances and indices of the nearest neighbors are calculated, and based at least in part on the indices of the nearest neighbors, data pertaining to the corresponding deals of the original (historical) dataset are extracted and returned as the prediction.

It is to be appreciated that this particular example pseudocode shows just one example implementation of at least a portion of a similarity-based prediction engine, and alternative implementations can be used in other embodiments.

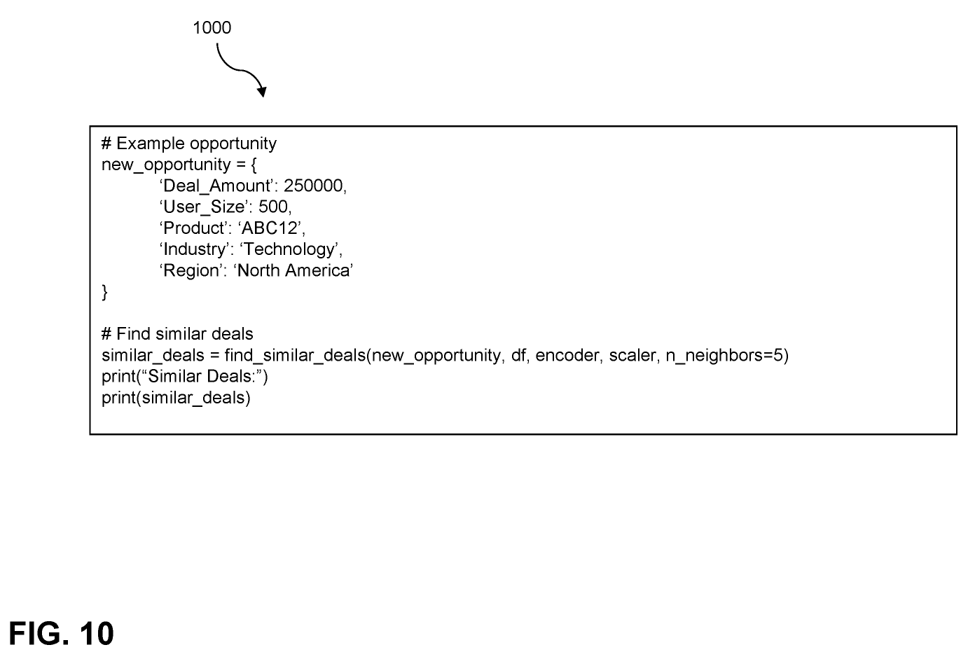

FIG. 10 shows example pseudocode for implementing at least a portion of a similarity-based prediction engine in an illustrative embodiment. In this embodiment, example pseudocode 1000 is executed by or under the control of at least one processing system and/or device. For example, the example pseudocode 1000 may be viewed as comprising a portion of a software implementation of at least part of machine learning-based recommendation system 105 of the FIG. 1 embodiment.

The example pseudocode 1000 illustrates an example implementation of a similarity-based prediction engine. More particularly, example pseudocode 1000 depicts an example involving a new opportunity which includes features of a deal amount of a designated approximate value, a customer size of a designated approximate value, a product type, an industry type, and a given geographic region. Based at least in part of such features, example pseudocode 1000 also details an instruction to find similar deals from at least one historical dataset and outputting data pertaining to such identified deals.

It is to be appreciated that this particular example pseudocode shows just one example implementation of at least a portion of a similarity-based prediction engine, and alternative implementations can be used in other embodiments.

Referring again to FIG. 2, the example embodiment depicted therein also includes implementation of the recommendation determination engine 214, which accepts and/or processes one or more portions of particular historical data (e.g., information pertaining to successful transactions similar to an input transaction) as predicted by the similarity-based prediction engine 212, and extracts information pertaining to one or more actions and/or activities associated with that historical data (e.g., actions carried out by sales agents for the successful transactions). Additionally, in such an embodiment, the recommendation determination engine 214 can perform such functions by leveraging NLP techniques and named entity recognition (NER) techniques using at least one pre-trained NLP model (e.g., spaCy).

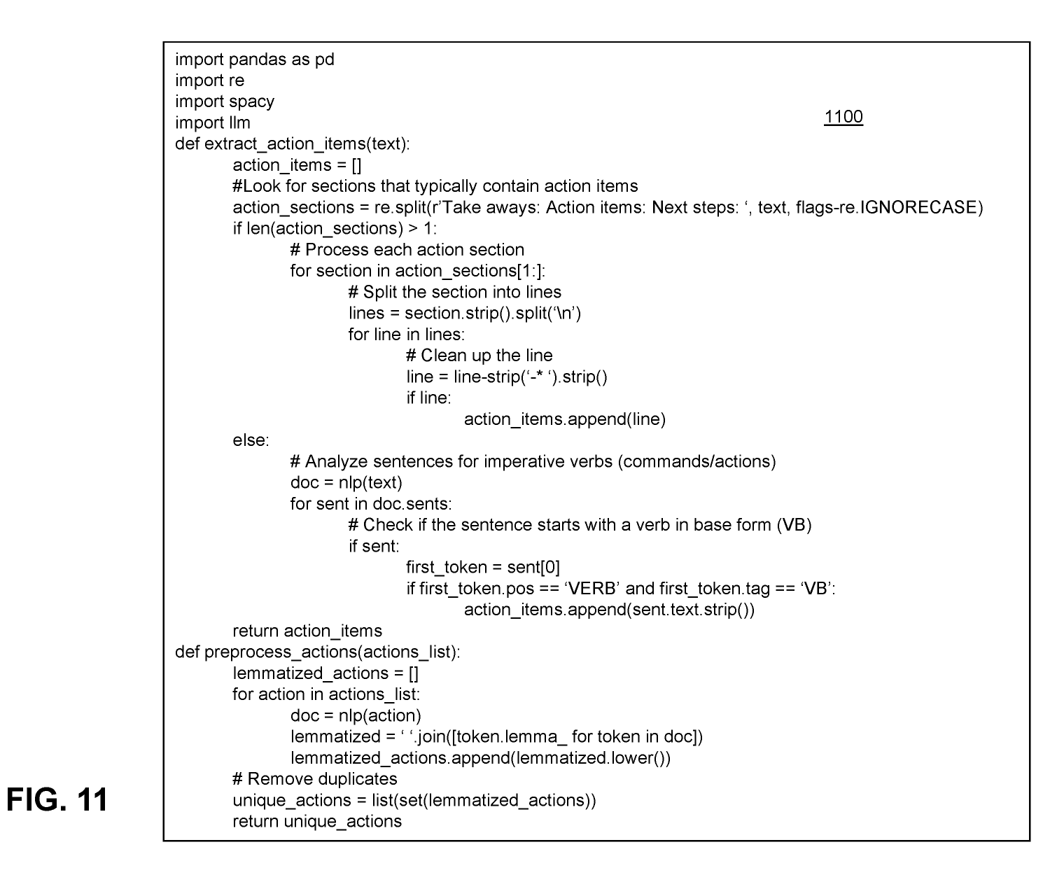

FIG. 11 shows example pseudocode for implementing at least a portion of a recommendation determination engine in an illustrative embodiment. In this embodiment, example pseudocode 1100 is executed by or under the control of at least one processing system and/or device. For example, the example pseudocode 1100 may be viewed as comprising a portion of a software implementation of at least part of machine learning-based recommendation system 105 of the FIG. 1 embodiment.

The example pseudocode 1100 illustrates importing Numpy, Pandas, and spaCy libraries and defining an action to extract action labels from unstructured transaction notes detailing successful deals. By processing such notes, the recommendation determination engine can identify actions that contributed to securing the deals. The implementation begins by loading the notes into a Pandas dataframe for structured handling. Then text preprocessing techniques, including tokenization and lemmatization, are applied to the loaded notes to normalize the text data therein. Additionally, using a spaCy language model, example pseudocode 1100 illustrates parsing the notes to detect one or more patterns indicative of action items (e.g., such as sections labeled “take aways,” bullet points, imperative sentences starting with verbs, etc.). The extracted action phrases are lemmatized to their base forms to ensure consistency, and duplicates are removed. Further, the actions can be categorized based at least in part on one or more predefined keywords and/or themes, transforming free-form text into structured labels that can be used for further analysis and/or as inputs for one or more predictive models.

It is to be appreciated that this particular example pseudocode shows just one example implementation of a recommendation determination engine, and alternative implementations can be used in other embodiments.

Referring yet again to FIG. 2, the example embodiment depicted therein also includes implementation of the actionable recommendation generation engine 216, which generates one or more recommendations on actions as steps to be carried out in connection with the corresponding input data and/or input query (e.g., steps to be carried out by the sales agents to follow in connection with an input transaction and/or opportunity). More particularly, in one or more embodiments, the actionable recommendation generation engine 216 can input the one or more action items extracted from historical data by the recommendation determination engine 214, and leverage at least one GenAI large language model (LLM) with RAG architecture to generate contextual steps to take in a designated language, and output those generated steps to user device 202-1 and/or user device 202-2. In one or more embodiments, a difference between the output of the recommendation determination engine 214 and the actionable recommendation generation engine 216 includes action words extracted from historical data notes output by the recommendation determination engine 214, and GenAI-generated instructions output by actionable recommendation generation engine 216.

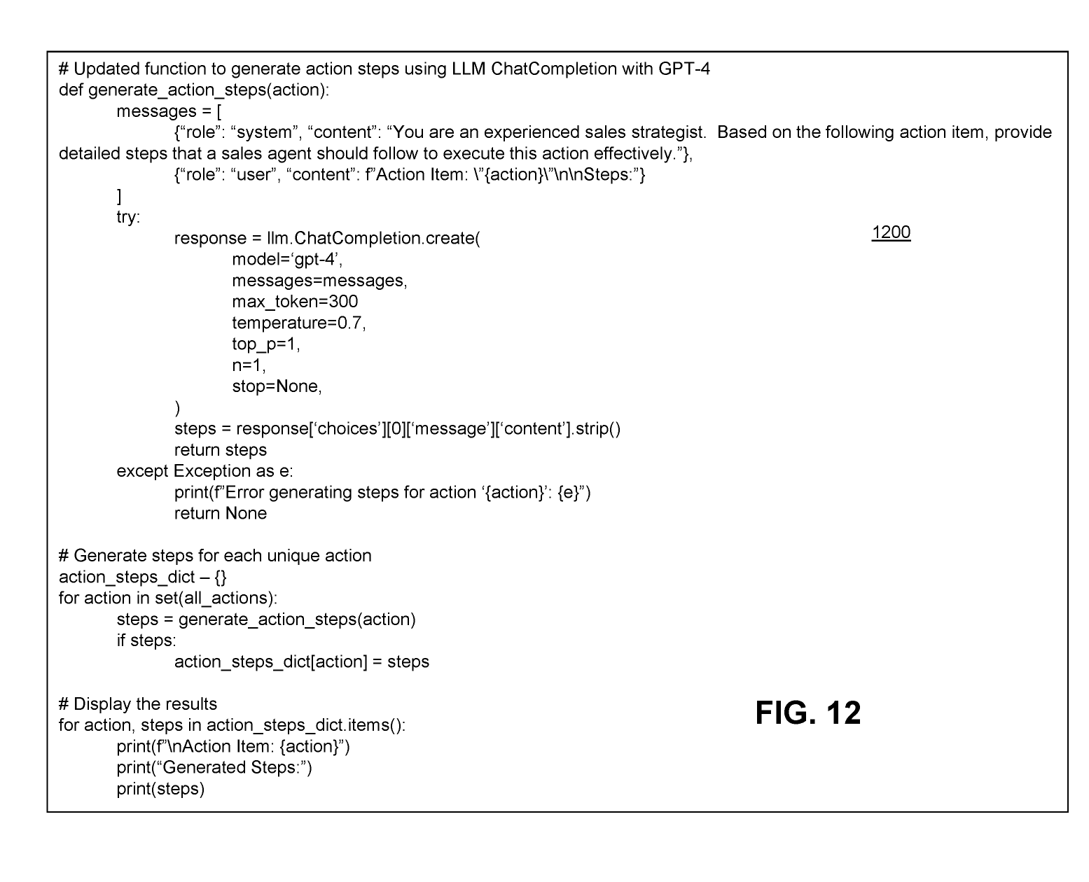

FIG. 12 shows example pseudocode for implementing at least a portion of an actionable recommendation generation engine in an illustrative embodiment. In this embodiment, example pseudocode 1200 is executed by or under the control of at least one processing system and/or device. For example, the example pseudocode 1200 may be viewed as comprising a portion of a software implementation of at least part of machine learning-based recommendation system 105 of the FIG. 1 embodiment.

The example pseudocode 1200 illustrates converting at least a portion of the extracted action labels (generated by the recommendation determination engine, such as detailed in connection with FIG. 11) into detailed instructions and/or activities for one or more systems and/or users (e.g., sales agents). Such conversion can be carried out at least in part by using one or more generative pretrained transformer model (e.g., a GPT-4 language model).

By way of example, sales knowledge articles and/or other support articles can be encoded and stored as the sales context in at least one vector store. Once a list of actions from the recommendation determination engine is fed to the actionable recommendation generation engine, a similarity search is carried out on at least one the context vector store to identify at least one similar sales context. One or more embodiments include crafting prompts that present each action label to the model (e.g., an LLM) within that context that encourages the generation of practical, actionable steps. Implementation steps can include setting up the LLM application programming interface (API) with the necessary credentials and defining a function that interacts with the ChatCompletion.create() endpoint. In this function, a conversational prompt is constructed wherein the system message sets the role of the assistant as an experienced sales strategist, and the user message provides the action item needing elaboration. The model then generates one or more detailed steps and/or strategies that sales agents can follow to execute the action effectively. By leveraging the advanced language understanding capabilities of one or more LLMs, such an embodiment can include transforming succinct action labels into comprehensive guidance, enabling sales agents to replicate successful behaviors in future deals.

By way merely of example and illustration, such output guidance in connection with a new resource-related migration and resource-related proration opportunity input examples can include the following:

Action Item: Change control team and datum privacy will have to be involved once the migration process is initiated.

Generated Steps:
1. Understand the migration process: Start by thoroughly understanding the migration process. This will involve understanding what is being migrated, why, and how. You should also understand the roles of the different teams involved.
2. Engage with the change control team: The change control team is responsible for managing and controlling changes to the system or product. Arrange a meeting with this team to discuss the migration and the role they will play.
3. Engage with the data privacy team. The data privacy team is responsible for ensuring that all data is handled in line with legal and enterprise guidelines. Arrange a meeting with this team to discuss the migration and the role they will play.
4. Develop a plan: Work with the change control team and the data privacy team to develop a plan for the migration. This should include the roles and responsibilities of each team, the timeline for the migration, and the steps to be taken.
5. Communicate the plan: Once the plan has been developed, ensure that it is communicated to all relevant parties. This should include the sales team, the IT team, and any other teams that will be affected by the migration.
6. Implement the plan: With the plan in place, the next step is to implement it. Monitor the progress of the migration, ensuring that all steps are being followed and that any issues are addressed promptly.
7. Review: After the plan has been completed, review results.

Action Item: Proration from monthly to daily.

Generated Steps:
1. Understand the proration concept: Proration is a method of distributing or allocating a certain amount of a resource over a specified period of time, such as a month or a day.
2. Identify the monthly amount: Determine the monthly amount that needs to be prorated to a daily basis. This could be a subscription fee, a service charge, or any other type of recurring payment.
3. Calculate the number of days in the given month: Use the correct number of days for the month in question.
4. Perform the proration calculation: Divide the monthly amount by the number of days in the month to get the daily rate.
5. Apply the daily rate: Multiply the daily rate by the number of days the customer will be using the service in that month.
6. Communicate the prorated amount: Inform the customer about the prorated amount.

It is to be appreciated that this particular example pseudocode shows just one example implementation of an actionable recommendation generation engine, and alternative implementations can be used in other embodiments.

FIG. 13 is a flow diagram of a process for implementing a machine learning-based recommendation system with data structure processing in an illustrative embodiment. It is to be understood that this particular process is only an example, and additional or alternative processes can be carried out in other embodiments.

In this embodiment, the process includes steps 1300 through 1308. These steps are assumed to be performed by the machine learning-based recommendation system 105 utilizing elements 112, 114 and 116.

Step 1300 includes identifying one or more features within input data associated with at least one action-based use case. In at least one embodiment, identifying one or more features within input data includes processing at least a portion of the input data using one or more rule-based techniques.

Step 1302 includes determining, by processing at least a portion of the one or more features within the input data using one or more machine learning techniques, one or more portions of historical data associated with one or more use cases having at least a designated level of similarity to the at least one action-based use case. In one or more embodiments, determining one or more portions of historical data associated with one or more use cases having at least a designated level of similarity to the at least one action-based use case includes clustering, using at least one neural network-based sparse auto-encoder, portions of the historical data stored in one or more data structures based at least in part on the one or more features. In such an embodiment, determining one or more portions of historical data associated with one or more use cases having at least a designated level of similarity to the at least one action-based use case can include processing the clustered historical data using at least one similarity algorithm to identify at least a portion of the clustered historical data that is associated with the one or more use cases having at least a designated level of similarity to the at least one action-based use case.

Step 1304 includes identifying, within the one or more determined portions of historical data, one or more activities carried out in furtherance of the one or more use cases having at least a designated level of similarity to the at least one action-based use case. In at least one embodiment, identifying one or more activities includes processing at least a portion of the one or more determined portions of historical data using one or more NLP techniques and at least one classification algorithm. In such an embodiment, identifying one or more activities can include processing the at least a portion of the one or more determined portions of historical data using one or more NER techniques in conjunction with the one or more natural language processing techniques.

Step 1306 includes generating one or more context-specific recommendations of one or more actions to be carried out in furtherance of the at least one action-based use case by processing the one or more identified activities using one or more generative artificial intelligence techniques. In one or more embodiments, generating one or more context-specific recommendations includes processing the one or more identified activities using the one or more generative artificial intelligence techniques in conjunction with at least one RAG framework. Additionally or alternatively, generating one or more context-specific recommendations can include generating a sequence of multiple actions to be carried out, by at least one of one or more user devices and one or more systems, in furtherance of the at least one action-based use case.

Step 1308 includes performing one or more automated actions based at least in part on the one or more generated context-specific recommendations. In at least one embodiment, performing one or more automated actions includes automatically initiating at least one of the one or more actions in conjunction with one or more systems associated with the input data. Additionally or alternatively, performing one or more automated actions can include automatically training at least a portion of at least one of the one or more machine learning techniques and the one or more generative artificial intelligence techniques based at least in part on feedback related to the one or more generated context-specific recommendations.

Accordingly, the particular processing operations and other functionality described in conjunction with the flow diagram of FIG. 13 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically generate actionable recommendations for an input use case by processing historical data using machine learning techniques and generative artificial intelligence. These and other embodiments can effectively overcome problems associated with errors, latencies, and/or resource-intensive remedial actions arising from inconsistent results and performance discrepancies.

It is to be appreciated that the particular advantages described above and elsewhere herein are associated with particular illustrative embodiments and need not be present in other embodiments. Also, the particular types of information processing system features and functionality as illustrated in the drawings and described above are examples only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

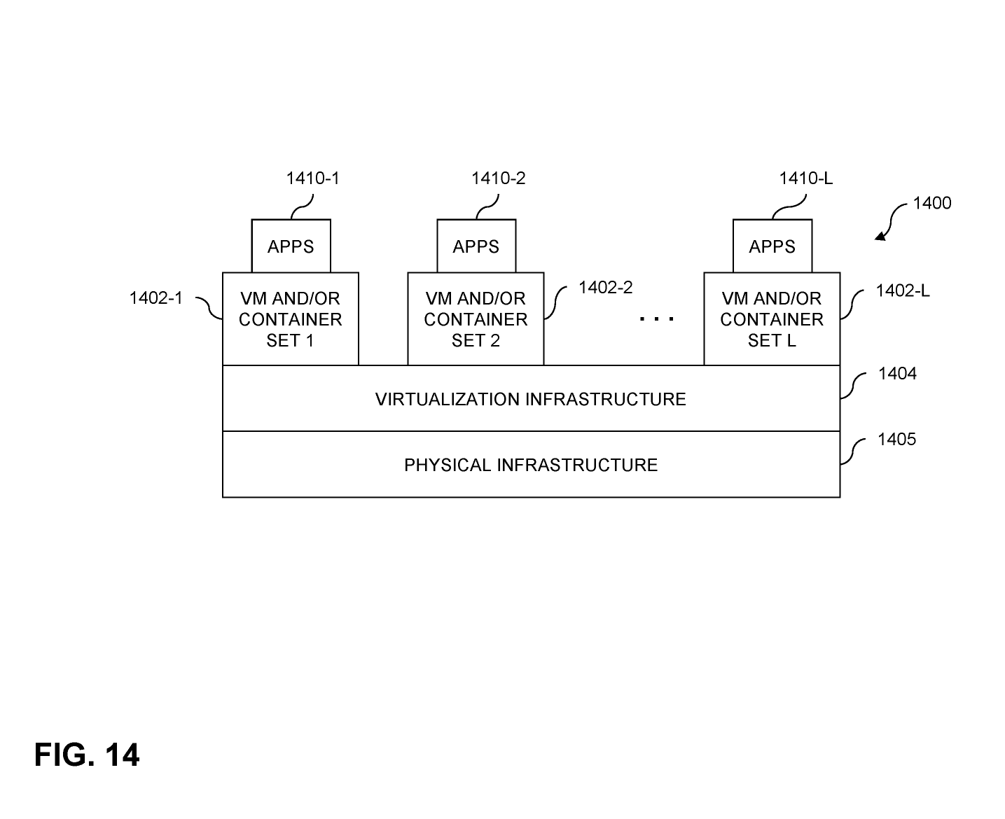

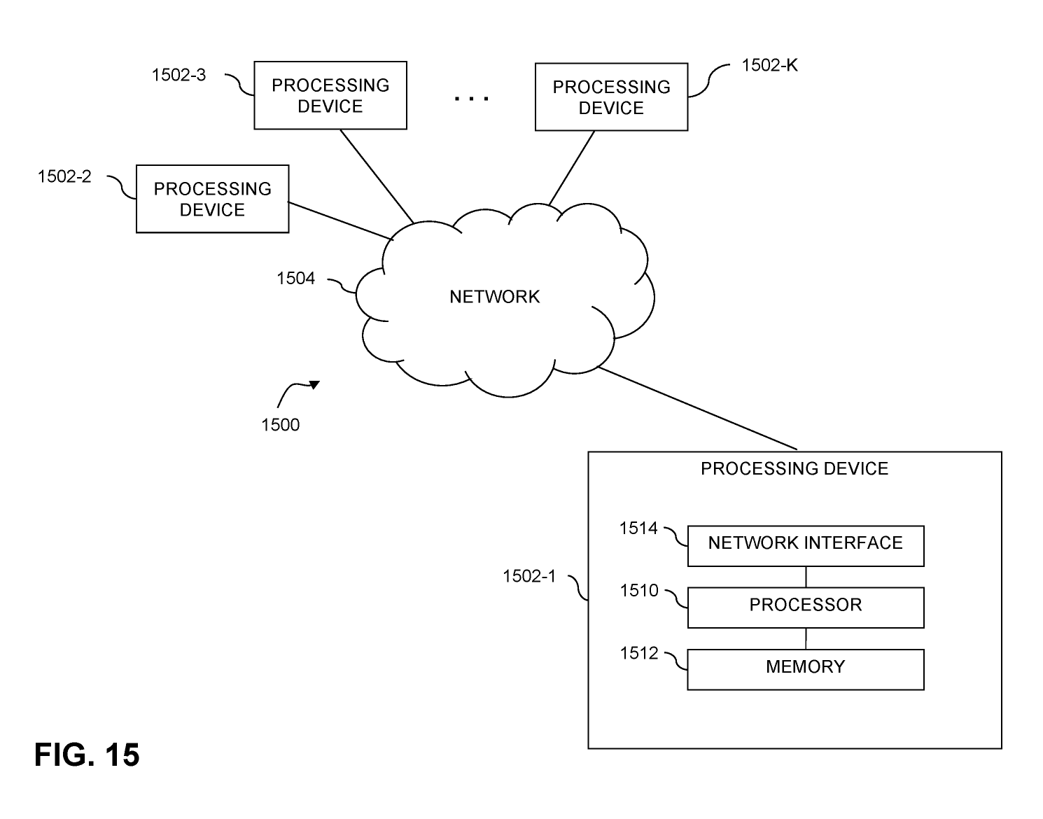

Illustrative embodiments of processing platforms will now be described in greater detail with reference to FIGS. 14 and 15. Although described in the context of system 100, these platforms may also be used to implement at least portions of other information processing systems in other embodiments.

FIG. 14 shows an example processing platform comprising cloud infrastructure 1400. The cloud infrastructure 1400 comprises a combination of physical and virtual processing resources that are utilized to implement at least a portion of the information processing system 100. The cloud infrastructure 1400 comprises multiple virtual machines (VMs) and/or container sets 1402-1, 1402-2, . . . 1402-L implemented using virtualization infrastructure 1404. The virtualization infrastructure 1404 runs on physical infrastructure 1405, and illustratively comprises one or more hypervisors and/or operating system level virtualization infrastructure. The operating system level virtualization infrastructure illustratively comprises kernel control groups of a Linux operating system or other type of operating system.

The cloud infrastructure 1400 further comprises sets of applications 1410-1, 1410-2, . . . 1410-L running on respective ones of the VMs/container sets 1402-1, 1402-2, . . . 1402-L under the control of the virtualization infrastructure 1404. The VMs/container sets 1402 comprise respective VMs, respective sets of one or more containers, or respective sets of one or more containers running in VMs. In some implementations of the FIG. 14 embodiment, the VMs/container sets 1402 comprise respective VMs implemented using virtualization infrastructure 1404 that comprises at least one hypervisor.

A hypervisor platform may be used to implement a hypervisor within the virtualization infrastructure 1404, wherein the hypervisor platform has an associated virtual infrastructure management system. The underlying physical machines comprise one or more information processing platforms that include one or more storage systems.

In other implementations of the FIG. 14 embodiment, the VMs/container sets 1402 comprise respective containers implemented using virtualization infrastructure 1404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1400 shown in FIG. 14 may represent at least a portion of one processing platform. Another example of such a processing platform is processing platform 1500 shown in FIG. 15.

The processing platform 1500 in this embodiment comprises a portion of system 100 and includes a plurality of processing devices, denoted 1502-1, 1502-2, 1502-3, . . . 1502-K, which communicate with one another over a network 1504.

The network 1504 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1502-1 in the processing platform 1500 comprises a processor 1510 coupled to a memory 1512.

The processor 1510 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one machine learning system and its associated machine learning algorithms provided by one or more processing devices as disclosed herein can be implemented using such circuitry.

The memory 1512 comprises RAM, ROM or other types of memory, in any combination. The memory 1512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1502-1 is network interface circuitry 1514, which is used to interface the processing device with the network 1504 and other system components, and may comprise conventional transceivers.

The other processing devices 1502 of the processing platform 1500 are assumed to be configured in a manner similar to that shown for processing device 1502-1 in the figure.

Again, the particular processing platform 1500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as examples rather than as requirements or limitations of the disclosure. Numerous other alternative embodiments within the scope of the appended claims will be readily apparent to those skilled in the art.

What is claimed is:

1. A computer-implemented method comprising:
identifying one or more features within input data associated with at least one action-based use case;
determining, by processing at least a portion of the one or more features within the input data using one or more machine learning techniques, one or more portions of historical data associated with one or more use cases having at least a designated level of similarity to the at least one action-based use case;
identifying, within the one or more determined portions of historical data, one or more activities carried out in furtherance of the one or more use cases having at least a designated level of similarity to the at least one action-based use case;
generating one or more context-specific recommendations of one or more actions to be carried out in furtherance of the at least one action-based use case by processing the one or more identified activities using one or more generative artificial intelligence techniques; and
performing one or more automated actions based at least in part on the one or more generated context-specific recommendations;
wherein the method is performed by at least one processing device comprising a processor coupled to a memory.

2. The computer-implemented method of claim 1, wherein determining one or more portions of historical data associated with one or more use cases having at least a designated level of similarity to the at least one action-based use case comprises clustering, using at least one neural network-based sparse auto-encoder, portions of the historical data stored in one or more data structures based at least in part on the one or more features.

3. The computer-implemented method of claim 2, wherein determining one or more portions of historical data associated with one or more use cases having at least a designated level of similarity to the at least one action-based use case comprises processing the clustered historical data using at least one similarity algorithm to identify at least a portion of the clustered historical data that is associated with the one or more use cases having at least a designated level of similarity to the at least one action-based use case.

4. The computer-implemented method of claim 1, wherein identifying one or more activities comprises processing at least a portion of the one or more determined portions of historical data using one or more natural language processing techniques and at least one classification algorithm.

5. The computer-implemented method of claim 4, wherein identifying one or more activities comprises processing the at least a portion of the one or more determined portions of historical data using one or more named entity recognition (NER) techniques in conjunction with the one or more natural language processing techniques.

6. The computer-implemented method of claim 1, wherein generating one or more context-specific recommendations comprises processing the one or more identified activities using the one or more generative artificial intelligence techniques in conjunction with at least one retrieval-augmented generation (RAG) framework.

7. The computer-implemented method of claim 1, wherein performing one or more automated actions comprises automatically initiating at least one of the one or more actions in conjunction with one or more systems associated with the input data.

8. The computer-implemented method of claim 1, wherein generating one or more context-specific recommendations comprises generating a sequence of multiple actions to be carried out, by at least one of one or more user devices and one or more systems, in furtherance of the at least one action-based use case.

9. The computer-implemented method of claim 1, wherein performing one or more automated actions comprises automatically training at least a portion of at least one of the one or more machine learning techniques and the one or more generative artificial intelligence techniques based at least in part on feedback related to the one or more generated context-specific recommendations.

10. The computer-implemented method of claim 1, wherein identifying one or more features within input data comprises processing at least a portion of the input data using one or more rule-based techniques.

11. A non-transitory processor-readable storage medium having stored therein program code of one or more software programs, wherein the program code when executed by at least one processing device causes the at least one processing device:
to identify one or more features within input data associated with at least one action-based use case;
to determine, by processing at least a portion of the one or more features within the input data using one or more machine learning techniques, one or more portions of historical data associated with one or more use cases having at least a designated level of similarity to the at least one action-based use case;
to identify, within the one or more determined portions of historical data, one or more activities carried out in furtherance of the one or more use cases having at least a designated level of similarity to the at least one action-based use case;
to generate one or more context-specific recommendations of one or more actions to be carried out in furtherance of the at least one action-based use case by processing the one or more identified activities using one or more generative artificial intelligence techniques; and
to perform one or more automated actions based at least in part on the one or more generated context-specific recommendations.

12. The non-transitory processor-readable storage medium of claim 11, wherein determining one or more portions of historical data associated with one or more use cases having at least a designated level of similarity to the at least one action-based use case comprises clustering, using at least one neural network-based sparse auto-encoder, portions of the historical data stored in one or more data structures based at least in part on the one or more features.

13. The non-transitory processor-readable storage medium of claim 11, wherein identifying one or more activities comprises processing at least a portion of the one or more determined portions of historical data using one or more natural language processing techniques and at least one classification algorithm.

14. The non-transitory processor-readable storage medium of claim 11, wherein generating one or more context-specific recommendations comprises processing the one or more identified activities using the one or more generative artificial intelligence techniques in conjunction with at least one retrieval-augmented generation (RAG) framework.

15. The non-transitory processor-readable storage medium of claim 11, wherein performing one or more automated actions comprises automatically initiating at least one of the one or more actions in conjunction with one or more systems associated with the input data.

16. An apparatus comprising:
at least one processing device comprising a processor coupled to a memory;
the at least one processing device being configured:
to identify one or more features within input data associated with at least one action-based use case;
to determine, by processing at least a portion of the one or more features within the input data using one or more machine learning techniques, one or more portions of historical data associated with one or more use cases having at least a designated level of similarity to the at least one action-based use case;
to identify, within the one or more determined portions of historical data, one or more activities carried out in furtherance of the one or more use cases having at least a designated level of similarity to the at least one action-based use case;
to generate one or more context-specific recommendations of one or more actions to be carried out in furtherance of the at least one action-based use case by processing the one or more identified activities using one or more generative artificial intelligence techniques; and
to perform one or more automated actions based at least in part on the one or more generated context-specific recommendations.

17. The apparatus of claim 16, wherein determining one or more portions of historical data associated with one or more use cases having at least a designated level of similarity to the at least one action-based use case comprises clustering, using at least one neural network-based sparse auto-encoder, portions of the historical data stored in one or more data structures based at least in part on the one or more features.

18. The apparatus of claim 16, wherein identifying one or more activities comprises processing at least a portion of the one or more determined portions of historical data using one or more natural language processing techniques and at least one classification algorithm.

19. The apparatus of claim 16, wherein generating one or more context-specific recommendations comprises processing the one or more identified activities using the one or more generative artificial intelligence techniques in conjunction with at least one retrieval-augmented generation (RAG) framework.

20. The apparatus of claim 16, wherein performing one or more automated actions comprises automatically initiating at least one of the one or more actions in conjunction with one or more systems associated with the input data.
